(19) United States
(12) Patent Application Publication
(10) Pub. No.: US 2025/0086530 A1
(43) Pub. Date: Mar. 13, 2025

(54) SYSTEMS AND METHODS FOR OPERATING A CLOTHING ALTERATION BUSINESS

(71) Applicant: Otgontugs T. King, Westfield, IN (US)

(72) Inventor: Otgontugs T. King, Westfield, IN (US)

(21) Appl. No.: 18/830,276

(22) Filed: Sep. 10, 2024

Related U.S. Application Data
(60) Provisional application No. 63/538,014, filed on Sep. 12, 2023.

(51) Int. Cl. G06Q 10/063; A41H 42/00

(52) U.S. Cl. CPC G06Q 10/063; A41H 42/00

(57) ABSTRACT

Systems and methods for operating a clothing alteration business. A method for operating at least a portion of a clothing alteration business includes the steps of fitting one or more garments upon a wearer, pinning the one or more garments in an alteration configuration using pins, removing the one or more garments from the wearer, ticketing the one or more garments with a primary ticket, and hanging the one or more garments on a first rack or a second rack, wherein the first rack corresponds to a first week and the second rack corresponds to a second week.

### PRIORITY

The present application is related to, and claims the priority benefit of, U.S. Provisional Patent Application Ser. No. 63/538,014, filed Sep. 12, 2023, the contents of which are incorporated herein directly and by reference in their entirety.

### BRIEF SUMMARY

The present disclosure includes disclosure of a method for operating at least a portion of a clothing alteration business, comprising the steps of fitting one or more garments upon a wearer, pinning the one or more garments in an alteration configuration using pins, removing the one or more garments from the wearer, ticketing the one or more garments with a primary ticket, and hanging the one or more garments on a first rack or a second rack, wherein the first rack corresponds to a first week and the second rack corresponds to a second week.

The present disclosure includes disclosure of a method for operating at least a portion of a clothing alteration business, further comprising separating the one or more garments from one another in the event the one or more garments comprises two or more garments, and individually ticketing each garment of the two or more garments with secondary tickets, wherein each secondary ticket of the secondary tickets corresponds to the primary ticket, the method performed to ultimately result in the one or more garments being tailored, steamed or pressed, and bagged.

The present disclosure includes disclosure of a method for operating at least a portion of a clothing alteration business, further comprising placing the one or more garments on a third rack with the primary ticket in the event the one or more garments comprises one garment, and placing the one or more garments on a third rack with the secondary tickets in the event the one or more garments comprises two or more garments.

The present disclosure includes disclosure of a method for operating at least a portion of a clothing alteration business, further comprising marking the one or more garments at the pins using chalk, and removing the pins.

The present disclosure includes disclosure of a method for operating at least a portion of a clothing alteration business, wherein the steps of pinning the one or more garments and marking the one or more garments are performed by the same person.

The present disclosure includes disclosure of a method for operating at least a portion of a clothing alteration business, further comprising placing the one or more garments on a fourth rack, a sixth rack, or a seventh rack, wherein the one or more garments will ultimately be placed on a fifth rack, an eighth rack, and/or a ninth rack, wherein the fourth rack corresponds to staging for preparation of the one or more garments, wherein a fifth rack corresponds to the one or more garments from the fourth rack that have been prepared, wherein the sixth rack corresponds to staging the one or more garments for sewing, and wherein the seventh rack corresponds to staging the one or more garments for serging, wherein an eighth rack corresponds to staging the one or more garments for blind stitching, and wherein a ninth rack corresponds to quality control of the one or more garments.

The present disclosure includes disclosure of a method for operating at least a portion of a clothing alteration business, and if the one or more garments were placed on the fourth rack, the method further comprising altering the one or more garments by removing stitches and/or buttons, placing the one or more garments on the fifth rack, optionally taking the one or more garments from the fifth rack and performing additional marking using chalk, and placing the one or more garments on the sixth rack, sewing the one or more garments, and placing the one or more garments on the ninth rack.

The present disclosure includes disclosure of a method for operating at least a portion of a clothing alteration business, and if the one or more garments were placed on the sixth rack, the method further comprising sewing the one or more garments, and placing the one or more garments on the ninth rack.

The present disclosure includes disclosure of a method for operating at least a portion of a clothing alteration business, and if the one or more garments were placed on the seventh rack, the method further comprising serging the one or more garments, placing the one or more garments on the eighth rack, blind stitching the one or more garments, and placing the one or more garments on the ninth rack.

The present disclosure includes disclosure of a method for operating at least a portion of a clothing alteration business, further comprising inspecting the one or more garments to confirm their altered conditions, and steaming or pressing the one or more garments.

The present disclosure includes disclosure of a method for operating at least a portion of a clothing alteration business, further comprising bundling each garment of the one or more garments that have secondary tickets if the one or more garments comprises two or more garments, bagging the one or more garments, and placing the one or more garments on a tenth rack.

The present disclosure includes disclosure of a method for operating at least part of a clothing alteration business, as shown and/or described herein.

The present disclosure includes disclosure of a system for operating at least part of a clothing alteration business, as shown and/or described herein.

The present disclosure includes disclosure of a method, comprising providing a plurality of clothing racks, the clothing racks comprising a first rack corresponding to a first week, a second rack corresponding to a second week, a third rack corresponding to one or more garments having a primary ticket, a fourth rack corresponding to staging for preparation of the one or more garments, and a fifth rack corresponding to the one or more garments from the fourth tack that have been prepared, fitting the one or more garments upon a wearer, pinning the one or more garments in an alteration configuration using pins, removing the one or more garments from the wearer, ticketing the one or more garments with the primary ticket, and hanging the one or more garments on the first rack or the second rack, the method performed to ultimately result in the one or more garments being tailored, steamed or pressed, and bagged.

The present disclosure includes disclosure of a method, further comprising separating the one or more garments from one another in the event the one or more garments comprises two or more garments, and individually ticketing each garment of the two or more garments with secondary tickets, wherein each secondary ticket of the secondary tickets corresponds to the primary ticket.

The present disclosure includes disclosure of a method, further comprising placing the one or more garments on the third rack with the primary ticket in the event the one or more garments comprises one garment, and placing the one or more garments on the third rack with the secondary tickets in the event the one or more garments comprises two or more garments.

The present disclosure includes disclosure of a method, further comprising placing the one or more garments on the fourth rack, altering the one or more garments by removing stitches and/or buttons, placing the one or more garments on the fifth rack, performing additional marking on the one or more garments using chalk, placing the one or more garments on a sixth rack, and sewing the one or more garments.

The present disclosure includes disclosure of a method, further comprising placing the one or more garments on a seventh rack, serging the one or more garments, placing the one or more garments on an eighth rack, blind stitching the one or more garments, and placing the one or more garments on a ninth rack.

The present disclosure includes disclosure of a method, further comprising placing the one or more garments on a ninth rack.

The present disclosure includes disclosure of a method, further comprising inspecting the one or more garments to confirm their altered conditions, and steaming or pressing the one or more garments.

The present disclosure includes disclosure of a method, further comprising bundling each garment of the one or more garments that have secondary tickets if the one or more garments comprises two or more garments, bagging the one or more garments, and placing the one or more garments on a tenth rack.

The present disclosure includes disclosure of a method, further comprising inspecting the one or more garments to confirm their altered conditions, steaming or pressing the one or more garments, bundling each garment of the one or more garments that have secondary tickets if the one or more garments comprises two or more garments, bagging the one or more garments, and placing the one or more garments on a tenth rack.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a process flow chart of various tasks to be performed, according to an exemplary embodiment of the present disclosure; and

FIG. 2 shows a process flow chart of various tasks to be performed in connection with the use of a plurality of racks, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a method for operating at least a portion of a clothing alteration business.

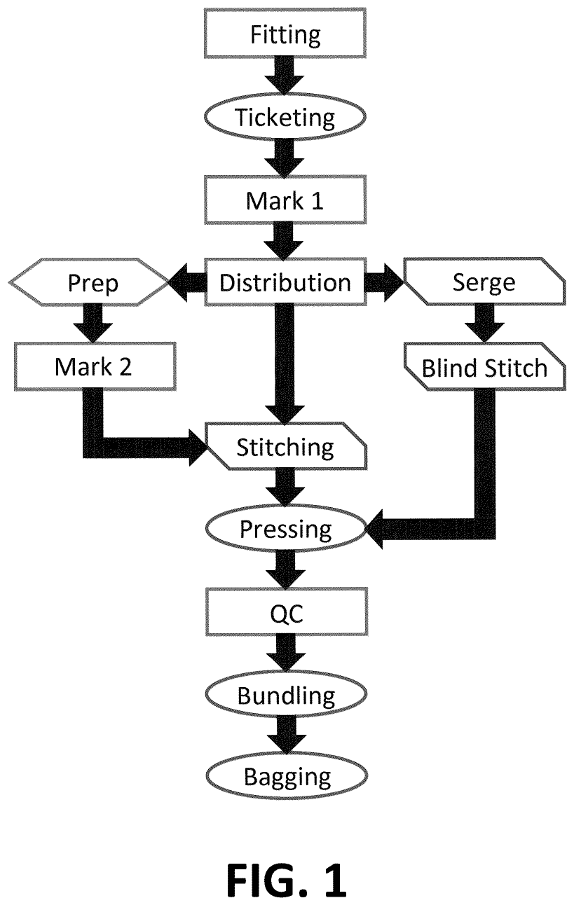

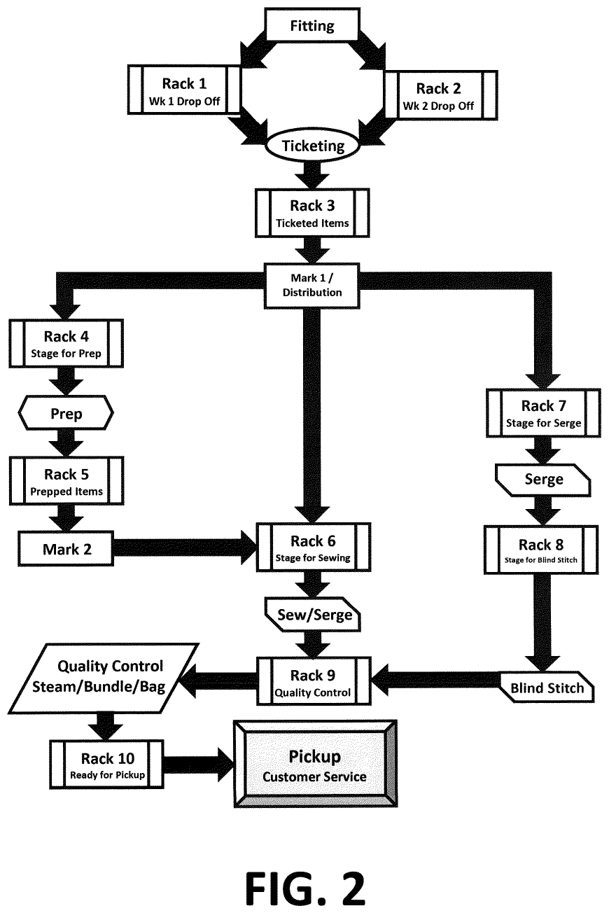

The steps referenced herein are depicted in FIG. 1 and FIG. 2. As shown in FIG. 1, several tasks can be performed consistent with the use of the various racks as depicted in FIG. 2. FIG. 1 also shows an optional “Responsibilities” section, identifying the various users of the systems and methods depicted herein, such as, for example, a “fitter” who would perform one or more of the initial fitting, the initial marking, distribution, the second marking, and the quality control. A “support” user could perform one or more of the ticketing, pressing, bundling, and bagging steps. A “prep” or “preparation” user could perform the preparation work as referenced herein. A “stitching” user could perform one or more of the serging, blind stitching, and stitching steps. Other user types, such as “customer service,” “admin” or “administrative,” and “management” can participate in and/or supervise any number of activities shown in FIG. 1. It is noted that any number of users, and any type of user, could be utilized to perform one or more of the steps identified in FIG. 1.

FIG. 2 outlines the various tasks identified in FIG. 1, and also depicts the use of any number of potential racks in connection with the process. As shown therein, an initial task performed in connection with clothing alterations is fitting. Using pins, the fitter can adjust the garments to be altered to achieve a proper fit according to the client's desires. A primary order ticket can be filled out at the time of fitting or soon thereafter with the client's name, pickup date, number of items, requiring alterations, and optionally the payment status. The adjusted garments can then be hung on a first or a second rack, referred to herein as Rack 1 and Rack 2.
Example: One Tuesday a client comes in with a new suit that needs to be altered. The coat sleeves need to be shortened and the trousers need to be hemmed. After the client changes into the suit, the fitter folds the coat cuffs into the sleeves to the desired length and pins them into place. Likewise, the trouser cuffs are folded into the pant legs to the desired length and pinned into place. While the client is changing back into his street clothes, the fitter writes the required alterations on the back of the order ticket-“Coat-Shorten Sleeves” and “Pants-Hem”. After checkout, when the client receives the claim ticket, the client's name, the number of garments, and the payment status is written on the front. The suit is then placed on a single hanger and the ticket is hung on the hanger's hook.

With respect to the first rack and the second rack, Rack 1 (“Drop Off Week 1”) and Rack 2 (“Drop Off Week 2”), the goal is to have a consistent turn-around time of one week, for example. However, business may be so heavy that such a goal is not always attainable. To accommodate that, Rack 2 can serve as a business overflow rack.
Example: In at least one embodiment, a shop can do ten orders a day to consistently have a turn-around time of one week. On a particularly busy Tuesday, the shop receives fifteen orders. The first ten orders will be set for pickup on the following Tuesday, while the last five will be set for pickup on the Wednesday after. That means that only five orders the next day can be set for a Wednesday pickup, and any more will have to be set for Thursday. This will carry over day to day, and any excess before the week is done will be staged on Rack 2. (The numbers in this example are picked at random for illustrative purposes only.)
The hanger bearing the pinned suit and its corresponding ticket is placed on Rack 1. Since the pickup day is next Tuesday, a week from today, it is placed on the bar behind the tag marked for “Tuesday.”

Orders can be taken from Racks 1 and 2 for further ticketing. Single garment orders can be taken straight to Rack 3 with the original primary order ticket pinned to the garment. Multiple garment orders can be divided up and hung on individual hangers (1 item per hanger) and can be individually ticketed. The original primary ticket can be pinned to one garment, and any further garments can have separate, hand-written (or pre-printed) tickets pinned to them (referred to herein as “secondary tickets.” All tickets can have the original ticket number, pickup date, number of items, and specific alterations of the attached item. The ticketed items can then be placed on Rack 3.
Example: The shop assistant removes the hanger bearing a pinned suit and its ticket and takes it to a table for further ticketing. The trousers are removed from the hanger and placed on a pant hanger. A separate tag is filled out with the pickup date for next Tuesday, the order number printed on the original ticket, the required alteration—“Hem”—and the number of garments. The tag is then attached to the trousers by means of a safety pin fastened around a belt loop. The original ticket is attached to the suit coat by means of a safety pin fastened through one of the button holes. Since all the pertinent information is already on the ticket, nothing further needs to be written.

Rack 3 (containing the ticketed Items) therefore would contain individually ticketed garments ready for marking.
Example: The two hangers, one holding the ticketed coat and the other holding the ticketed trousers, are placed on Rack 3 behind the tag marked for “Tuesday.”

With respect to marking, “Mark 1” can refer to alterations originally designated by pin that can be marked with chalk. It is recommended that the original fitter takes care of the marking, as they already know what alteration is needed. The process at this point can split into one of three directions: marked items can typically be sent to either Rack 4 to stage for prep, Rack 6 to stage for sewing, or Rack 7 to stage for serging.
Example: The fitter pulls the coat and takes it to the marking table. Using tailoring chalk, the cuff lines are marked at the points where the pins are holding the cuffs in place, and then the pins are removed. The coat now has to have the sleeves opened before any further marking can occur, so it is hung on Rack 4. The fitter then pulls the trousers for marking. Just like the coat, the hem line is marked where the pins are holding it in place and then the pins are removed. Since no further prep work is required, the pant legs are straightened and, using a metal two-inch-wide ruler, a straight even chalk line is drawn connecting the prior chalk marks all the way around each pant leg. This line designates the entirety of the tailored hem. A second line is drawn two inches below the hem line, designating the cut line. The excess fabric is then cut off at that line, leaving the hem line two inches above the bottom of the trousers. The trousers are then turned inside-out and placed back on their hanger. They are now ready for serging, so they are hung on Rack 7.

Rack 4 (for preparation—referred to as the “Prep Rack”) is the staging area for prep work.
Example: The coat is hung on Rack 4 behind the tag marked for “Tuesday” to await the opening of the sleeves.

Preparation: Some garments will require further preparation before they can be sewed-opening sleeves, removing buttons, opening waistbands, removing top stitch, etc. All such work can be completed at this station before being placed on Rack 5.
Example: The shop assistant pulls the coat from Rack 4 and takes it to the prep table. Carefully using a seam-ripper, the buttons are first removed from the sleeve and placed in the inside pocket of the coat. Next, the lining is separated completely from the outer shell of the garment, and all stitches holding the existing cuff in place are removed, allowing the exterior fabric of the sleeve to be fully extended. The process is repeated on the other sleeve. The coat is now ready for final marking.

Rack 5 (Prepped Items) is the staging area for Mark 2 (the additional marking).
Example: The prepped coat is hung on Rack 5 behind the tag marked for “Tuesday” to await final marking.

Mark 2: after prep work, some garments will require final chalk marking before they are ready for sewing. All such work can be completed at this station before being placed on Rack 6.
Example: Now that the sleeves are opened, the fitter removes the coat from Rack 5 and takes it to the marking table. Using the two-inch-wide ruler, the fitter draws a straight even chalk line all the way around the sleeve, connecting the prior chalk marks designating the new cuff line. Just as with the trousers, a cut line is drawn two inches below cuff line and the excess fabric is removed. The coat is now ready for sewing.

Rack 6 (Sewing): this rack is the staging area for sewing. Garments can be received here from Mark 1 and Mark 2 and can be color coded. In an ideal shop layout, there can be at least two sewing stations. In such a case, each station can have its own Rack 6—they can then be identified as Rack 6.1, Rack 6.2, etc.
Example: The marked coat is hung on Rack 6.1 behind the tag marked for “Tuesday” to await sewing.

Sewing: most alterations can be conducted at this stage. Once complete, most can be sent straight to Rack 9 for Quality Control. Each sewing station should have its own ironing board as well for pressing and steaming purposes.
Example: The stitcher pulls the marked coat and sews the new cuffs into place at the marked cuff line, reattaching the lining and the buttons. The alteration is now complete and the coat is ready for final inspection.

Rack 7 (Serging): this rack is the staging area for serge work.
Example: The marked trousers are hung on Rack 7 behind the tag marked for “Tuesday” to await serging.

Serging: cut edges of fabric need to be protected against fraying and unravelling, which is the purpose of serging. All such work can be completed at this station before being placed on Rack 8 for blind stitching.
Example: The stitcher pulls the marked trousers and serges the cut edges of each pant leg. The serged trousers are now ready for blind stitching.

Rack 8 (Blind Stitching): This rack is the staging area for blind stitching.
Example: The serged trousers are hung on Rack 8 behind the tag marked for “Tuesday” to await blind-stitching.

Blind Stitching: this is the process of securing excess fabric for hems. All such work can be completed at this station before being placed on Rack 9 for Quality Control.
Example: The stitcher pulls the serged trousers and blind stitches the new hems into place at the marked hem line. The trousers are turned right-side out and hung back on the pant hanger, and then the hems are pressed using a steam iron. The alteration is now complete and the trousers are ready for final inspection.

Rack 9 (Quality Control (QC)): this rack is the staging area for Quality Control.
The finished coat and finished trousers are hung on Rack 9 behind the tag marked for “Tuesday to await final inspection.

QC: finished alterations are to be inspected at this station. Final steaming or pressing can take place at this time. Multi-garment orders are to be reconsolidated as well. All items are to be bagged before placing them on Rack 10 for pickup.
The finished coat and trousers are pulled and reconsolidated by order number for final inspection. The inspector insures that the hems and cuffs are laying straight and all stitches are even. The tickets are unpinned from the garments, and the garments are then steamed to remove wrinkles. The coat and trousers are bagged together and the original ticket is hung on the front hanger hook. The handwritten ticket is discarded. The order is now ready for pickup.

Rack 10 (Pickup): This rack holds all completed orders, organized by pickup date first and then ticket number.
The completed order is hung on Rack 10 behind the tag marked for “Tuesday.” It is placed in numerical order with the other orders to be picked up that same day.

While various embodiments of systems and methods have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A method for operating at least a portion of a clothing alteration business, comprising the steps of:
fitting one or more garments upon a wearer;
pinning the one or more garments in an alteration configuration using pins;
removing the one or more garments from the wearer;
ticketing the one or more garments with a primary ticket; and
hanging the one or more garments on a first rack or a second rack, wherein the first rack corresponds to a first week and the second rack corresponds to a second week;
the method performed to ultimately result in the one or more garments being tailored, steamed or pressed, and bagged.

2. The method of claim 1, further comprising:
separating the one or more garments from one another in the event the one or more garments comprises two or more garments; and
individually ticketing each garment of the two or more garments with secondary tickets, wherein each secondary ticket of the secondary tickets corresponds to the primary ticket.

3. The method of claim 2, further comprising:
placing the one or more garments on a third rack with the primary ticket in the event the one or more garments comprises one garment; and
placing the one or more garments on the third rack with the secondary tickets in the event the one or more garments comprises two or more garments.

4. The method of claim 3, further comprising:
marking the one or more garments at the pins using chalk; and
removing the pins.

5. The method of claim 4, wherein the steps of pinning the one or more garments and marking the one or more garments are performed by the same person.

6. The method of claim 4, further comprising:
placing the one or more garments on a fourth rack, a sixth rack, or a seventh rack, wherein the one or more garments will ultimately be placed on a fifth rack, an eighth rack, and/or a ninth rack;
wherein the fourth rack corresponds to staging for preparation of the one or more garments;
wherein a fifth rack corresponds to the one or more garments from the fourth rack that have been prepared;
wherein the sixth rack corresponds to staging the one or more garments for sewing; and
wherein the seventh rack corresponds to staging the one or more garments for serging;
wherein an eighth rack corresponds to staging the one or more garments for blind stitching; and
wherein a ninth rack corresponds to quality control of the one or more garments.

7. The method of claim 6, and if the one or more garments were placed on the fourth rack, further comprising:
altering the one or more garments by removing stitches and/or buttons;
placing the one or more garments on the fifth rack;
optionally taking the one or more garments from the fifth rack and performing additional marking using chalk;
placing the one or more garments on the sixth rack;
sewing the one or more garments; and
placing the one or more garments on the ninth rack.

8. The method of claim 6, and if the one or more garments were placed on the sixth rack, further comprising:
sewing the one or more garments; and
placing the one or more garments on the ninth rack.

9. The method of claim 6, and if the one or more garments were placed on the seventh rack, further comprising:
serging the one or more garments;
placing the one or more garments on the eighth rack;
blind stitching the one or more garments; and
placing the one or more garments on the ninth rack.

10. The method of any of claim 7, 8, or 9, further comprising:
inspecting the one or more garments to confirm their altered conditions; and
steaming or pressing the one or more garments.

11. The method of claim 10, further comprising:
bundling each garment of the one or more garments that have secondary tickets if the one or more garments comprises two or more garments;
bagging the one or more garments; and
placing the one or more garments on a tenth rack.

12. A method, comprising:
providing a plurality of clothing racks, the clothing racks comprising:
a first rack corresponding to a first week;
a second rack corresponding to a second week;
a third rack corresponding to one or more garments having a primary ticket;
a fourth rack corresponding to staging for preparation of the one or more garments; and
a fifth rack corresponding to the one or more garments from the fourth tack that have been prepared;
fitting the one or more garments upon a wearer;
pinning the one or more garments in an alteration configuration using pins;
removing the one or more garments from the wearer;
ticketing the one or more garments with the primary ticket; and
hanging the one or more garments on the first rack or the second rack;
the method performed to ultimately result in the one or more garments being tailored, steamed or pressed, and bagged.

13. The method of claim 12, further comprising:
separating the one or more garments from one another in the event the one or more garments comprises two or more garments; and
individually ticketing each garment of the two or more garments with secondary tickets, wherein each secondary ticket of the secondary tickets corresponds to the primary ticket.

14. The method of claim 13, further comprising:
placing the one or more garments on the third rack with the primary ticket in the event the one or more garments comprises one garment; and
placing the one or more garments on the third rack with the secondary tickets in the event the one or more garments comprises two or more garments.

15. The method of claim 14, further comprising:
placing the one or more garments on the fourth rack;
altering the one or more garments by removing stitches and/or buttons;
placing the one or more garments on the fifth rack;
performing additional marking on the one or more garments using chalk;
placing the one or more garments on a sixth rack; and
sewing the one or more garments.

16. The method of claim 15, further comprising:
placing the one or more garments on a seventh rack;
serging the one or more garments;
placing the one or more garments on an eighth rack;
blind stitching the one or more garments; and
placing the one or more garments on a ninth rack.

17. The method of claim 15, further comprising:
placing the one or more garments on a ninth rack.

18. The method of claim 16, further comprising:
inspecting the one or more garments to confirm their altered conditions; and
steaming or pressing the one or more garments.

19. The method of claim 18, further comprising:
bundling each garment of the one or more garments that have secondary tickets if the one or more garments comprises two or more garments;
bagging the one or more garments; and
placing the one or more garments on a tenth rack.

20. The method of claim 17, further comprising:
inspecting the one or more garments to confirm their altered conditions;
steaming or pressing the one or more garments;
bundling each garment of the one or more garments that have secondary tickets if the one or more garments comprises two or more garments;
bagging the one or more garments; and
placing the one or more garments on a tenth rack.
